(19) United States
(12) Patent Application Publication
(10) Pub. No.: US 2006/0109677 A1
(43) Pub. Date: May 25, 2006

(54) Sliding-type Electronic Device with a View Angle

(76) Inventor: Kai-Chung Hou, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,258

(22) Filed: Oct. 12, 2005

(30) Foreign Application Priority Data
Nov. 19, 2004 (TW) 093135771

(51) Int. Cl. F21V 7/04; A47F 3/00

(52) U.S. Cl. 362/561; 362/632

(57) ABSTRACT

An electronic device includes a first module, a sliding component including a first cantilever, a second cantilever including a sliding unit, and a flexible structure is being deformed so as to change the angle between the first cantilever and the second cantilever. The electronic device further includes a second module including a sliding track formed on a top surface of the second module, and the sliding unit can slide on the track of the second module. The electronic device further includes a support component protruding from the top surface of the second module for lifting an end of the first module upwards when the sliding unit slides to a position that the first module contacts the support component so that the flexible structure is being deformed to change the angle between the first cantilever and the second cantilever.

### BACKGROUND OF THE INVENTION

1. Field of the Invention

The present invention relates to an electronic device, more particularly, an electronic device with a view angle greater than zero degrees.

2. Description of the Prior Art

In highly developed information communication systems in modern information society, electronic devices are widely utilized in every area. For instance, the utilization of a convenient and lightweight mobile phone device has become a way of communication in our daily lives. Users can easily exchange and share information, experience, and opinions through the convenience of the mobile phone device. The mobile phone has progressed tremendously in recent years. Various types of mobile phones are continuously developed and the increasing utilization has created a demand in production. As mobile phones become more common, the technology of mobile phones has matured and the trend has moved toward multi-functional smaller phones. The important issue now: how to design a more convenient mobile phone for the user.

An initial design of the electronic device in the market place consisted of a slide construction. For example, an initial design for mobile phones utilized a slide construction. This was especially evident in the high-end segment of the mobile phone market. The slide construction mobile phone is smaller in comparison to the size of a straight vertical mobile phone. Additionally, slide construction mobile phones have keypads with a wider surface area.

Please refer FIG. 1. FIG. 1 illustrates an external view diagram of a conventional slide construction mobile phone 10. The slide construction mobile phone 10 comprises a first module 12 and a second module 14. The first module 12 is capable of moving in a sliding manner and is fixed above the second module 14. A user can push the first module 12 to achieve an opening movement of the slide construction mobile phone 10. The second module 14 comprises a processing unit (not shown in FIG. 1), installed within a casing of the second module 14 for controlling operations of the slide construction mobile phone 10, and a plurality of keypads 16, installed on a casing of the second module 14, for inputting control signals to the processing unit, the user can also perform the action of dialing a telephone by utilizing the keypads 16. The first module 12 comprises a display panel 18, installed on the casing of the first module 12, for displaying images processed by the slide construction mobile phone 10.

When the user wants to utilize the slide construction mobile phone 10, the user first needs to slide the first module 12 relative to the second module 14 toward direction X in order to operate the function of the keypads 16 of the second module 14. When the first module slides toward direction X, the angle between the first module 12 and the second module 14 does not change and the first module 12 and the second module 14 maintain at a horizontal status. After the slide construction mobile phone 10 is opened and the design of the phone looks like a long vertical mobile phone, when the user operates the keypads 16, the viewing angle of the display panel 18 will be not as suitable as a flip mobile phone, therefore it causes an inconvenience for the user when operating the mobile phone.

### SUMMARY OF THE INVENTION

The claimed invention relates to a slide construction electronic device with a view angle greater than zero degrees to solve the problem mentioned above.

The claimed invention discloses an electronic device, comprising: a first module, and a sliding component, comprising a first cantilever, fixed to the first module, a second cantilever, comprising a sliding unit, the first cantilever and the second cantilever are extended from a flexible structure, the flexible structure is being deformed to change the angle between the first cantilever and the second cantilever. The electronic device further comprises a second module, comprising a sliding track, formed on a top surface of the second module. The sliding unit slides on the sliding track and is coupled to the second module through the sliding track, and a support component, protruding from the top surface of the second module, for lifting an end of the first module upward when the sliding unit slides to a position that the first module makes contact with the support component so that the flexible structure is being deformed to change the angle between the first cantilever and the second cantilever.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an external view diagram of a conventional slide construction mobile phone.

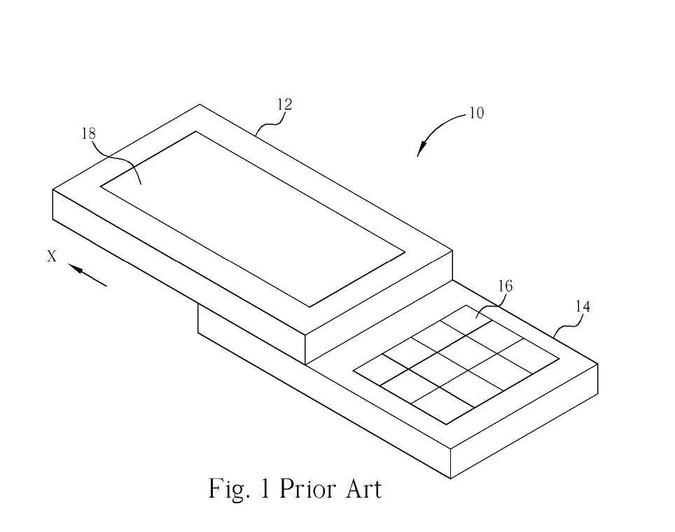

FIG. 2 illustrates an external view diagram of an electronic device according to the present invention.

FIG. 3 illustrates an internal structure diagram of a first module.

FIG. 4 illustrates a structure diagram of a sliding component.

FIG. 5 illustrates a diagram of a sliding component combining with a first module.

FIG. 6 illustrates an internal structure diagram of a second module.

FIG. 7 illustrates a diagram of a first module combining with a second module when an electronic device is closed completely.

FIG. 8 illustrates a diagram of a first module above a second module being lifted by a support module when an electronic device is opened.

FIG. 9 illustrates a transformation diagram of when a sliding component on a first module is being lifted.

### DETAILED DESCRIPTION

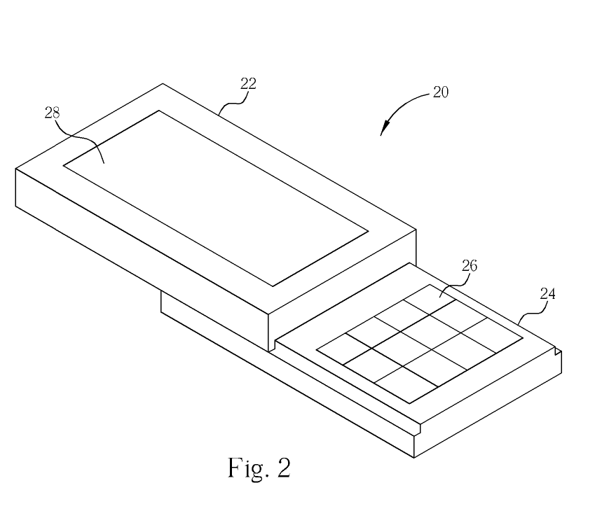

Please refer FIG. 2. FIG. 2 illustrates an external view diagram of an electronic device 20. The electronic device 20 can be a mobile phone, a personal digital assistant (PDA), and so on. The electronic device 20 comprises a first module 22 and a second module 24. The first module 22 can move in a sliding manner and it is fixed above the second module 24. A user can push the first module 22 to achieve opening movement of the electronic device 20. The second module 24 comprises a processing unit (not shown in FIG. 2), installed within a casing of the second module 24, for controlling operations of the electronic device 20 and a plurality of keypads 26, installed on the casing of the second module 24, for inputting control signals to the processing unit, the user can also perform the action of dialing a telephone by utilizing the keypads 26. The first module 22 comprises a display panel 28, installed on a casing of the first module 22, for displaying images processed by the electronic device 20.

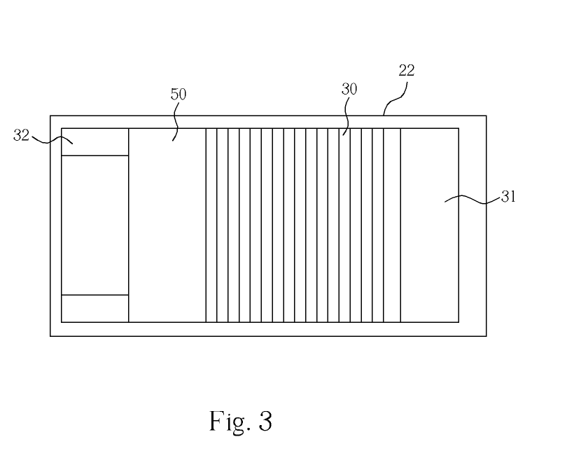

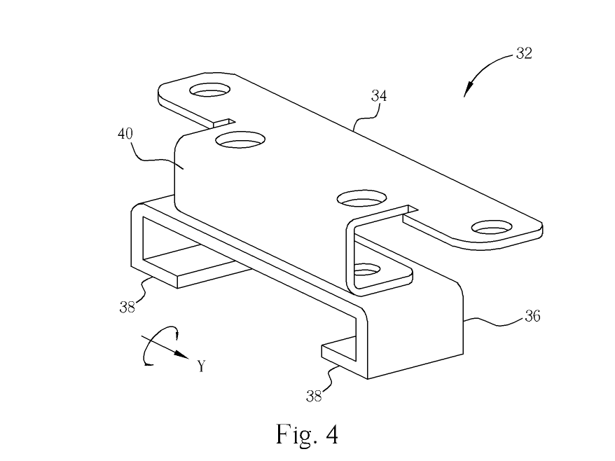

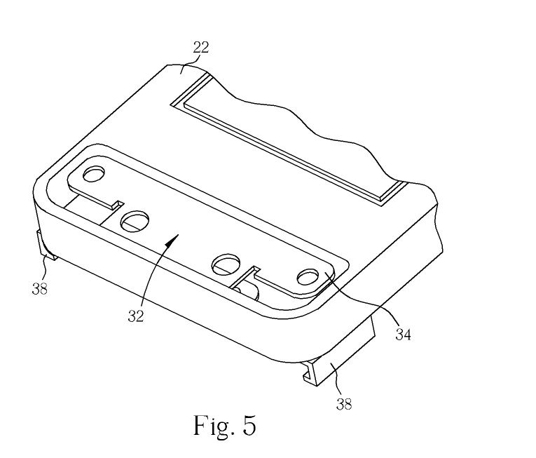

Please refer FIG. 3. FIG. 3 illustrates an internal structure diagram of a first module 22. The first module 22 comprises a first flat surface 50, a plurality of trenches are installed on the first flat surface 50, and a container 31. The electronic device 20 further comprises a sliding component 32, an end of the sliding component 32 is fixed on the first flat surface 50 of the first module 22. Please refer to FIG. 4. FIG. 4 illustrates a structure diagram of a sliding component 32. The sliding component 32 comprises a first cantilever 34, fixed to the first module 22, a second cantilever 36, comprising a sliding unit 38, and a flexible structure 40, which can be a metallic plate or a rotating axel, a Y axel can be represented as a shaft to perform rotating deformation, and the first cantilever 34 and the second cantilever 36 are extended from the flexible structure, the flexible structure can be deformed to change the angle between the first cantilever and the second cantilever. Please refer to FIG. 5. FIG. 5 illustrates a diagram of a sliding component 32 combining with a first module 22. The sliding component 32 is fixed on the first module 22 via the first cantilever 34, the sliding unit 38 is protruded from the underneath surface of the first module 22.

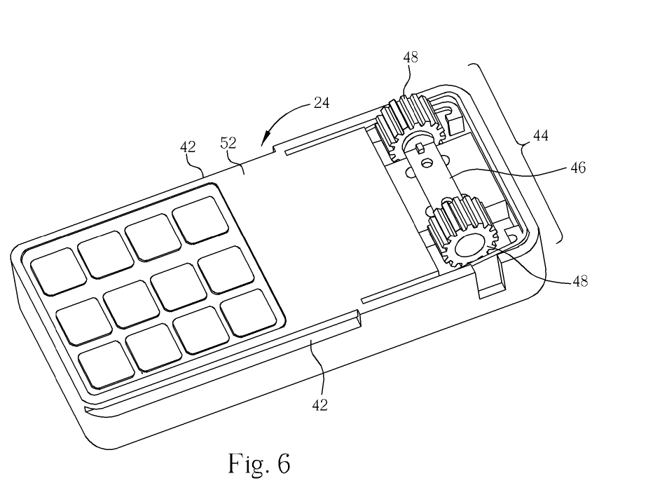

Please refer to FIG. 6. FIG. 6 illustrates an internal structure diagram of a second module 24. The second module 24 having a second flat surface 52, and further comprising two sliding tracks 42, formed on the second flat surface 52, the sliding unit 38 of the sliding component 32 can move in a sliding manner on the sliding track 42 of the second module 24 fixed on the second module, at this time, the first surface 50 of the first module 22 faces the second flat surface 52 of the second module 24. The electronic device 20 further comprises a support component 44, protruding from the second surface 52 of the second module 24, in this embodiment, the support component 44 comprises a shaft 46, and two gears 48 covering the shaft 46 in a rotating manner, for lifting the first module upward, and the gears 48 can also be replaced by two rollers. The contact surface of the shaft 46 and the two gears 48 can be applied with damping oil other oils or fluids, so that there is an obstructing feeling when the gears 48 are coiling the shaft 46 to improve the feeling of controlling the first module 22 is sliding relative to the second module 24. Please refer to FIG. 3, FIG. 4, and FIG. 6. When the sliding unit 38 of the sliding component 32 is sliding on the sliding tracks 42 of the second module 24, the two gears of the supporting component 44 are then capable of engaging with a plurality of trenches 30 of the first module 22 to prevent the first module 22 from sliding too fast on the second module, in utilizing the method of applying the damping oil, the feeling of sliding the first module 22 can be achieved.

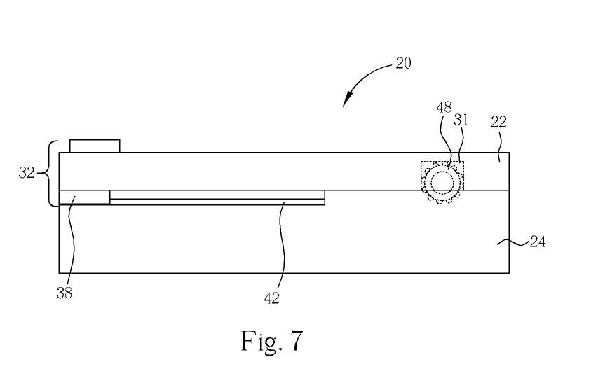

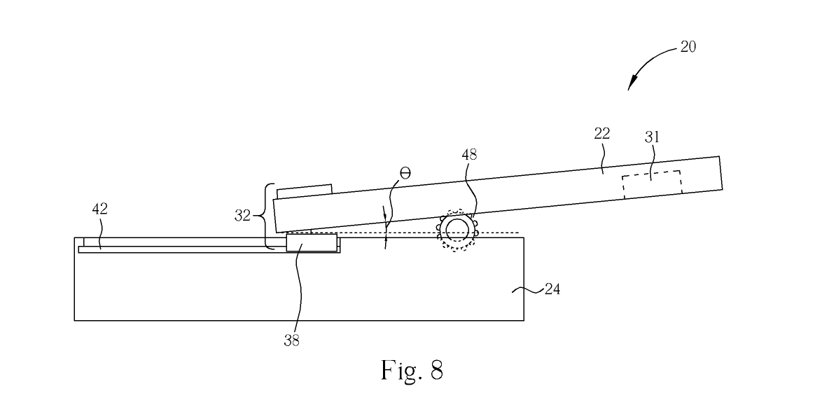

Please refer to FIG. 7 and FIG. 8. FIG. 7 illustrates a diagram of a first module 22 combining with a second module 24 when an electronic device 20 is closed completely. FIG. 8 illustrates a diagram of a first module 22 above a second module 24 being lifted by a support module when an electronic device 20 is opened. The first module 22 can slide on the sliding track 42 of the second module 24 through the sliding unit 38 of the sliding component, when the electronic device 20 is completely closed, the sliding unit 38 is located at the end of the sliding tracks 42, at this time, the two gears 48 of the support component 44 protruding on the top surface of the second module 24 are located in a cavity 31 of the first module 22, whereas the two gears do not lift the first module 22 as shown in FIG. 7. When the sliding unit 38 slides on the sliding tracks 42 to a position that the first module 22 contacts the support component 44 the gears 48 of the support component 44 then lifts the front end of the first module 22. As the distance that the sliding unit 38 is sliding forward on the sliding tracks 42 increases the angle also changes according to the first module 22, being lifted upwards, and the second module. In other words, the angleθ change and the radius of the gears 48 and the distance from the end of the first module 22 to the center of the gears 48 is approximately tan θ (radius of the gears 48/the distance from the end of first module to the center of the gears 48), therefore in controlling the length of the radius of the gears 48 or the length of the sliding tracks 42 (minimum length of the end of the first module 22 sliding to the center of the gears 48), the size of the angleθ can be controlled. When the user slides the first module 22, a view angle greater than zero degrees is formed between the first module 22 and the second module 24. This means that at this time the display panel 28 of the first module 22 and the keypads 26 of the second module 24 form a view angle greater than zero degrees, therefore it is more convenient for the user to view the display when operating the electronic device 20.

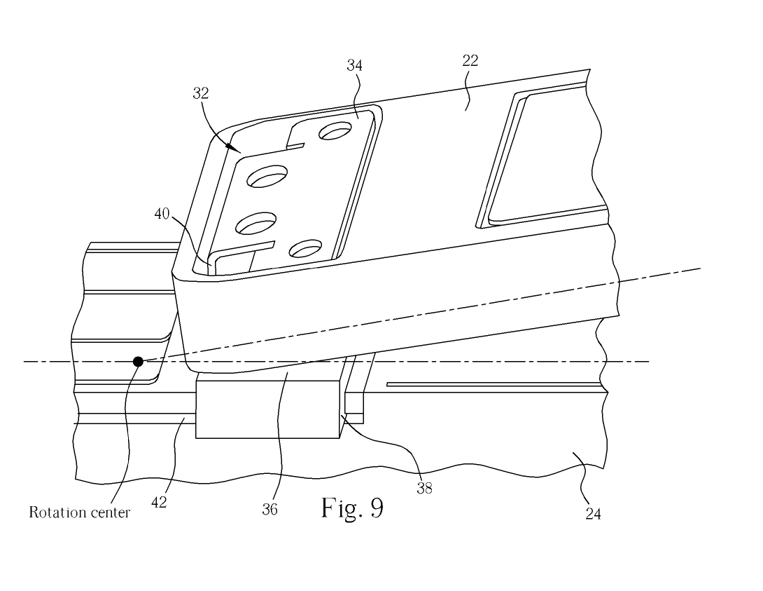

Please refer to FIG. 9. FIG. 9 illustrates a change diagram of when a sliding component on a first module 22 is being lifted. When the first module 22 is being lifted, as the first cantilever 34 of the sliding component is fixed to the first module 22, it is also being lifted by the first module 22, the second cantilever 36 is coupled to the sliding tracks 42 fixed on the sliding unit 38, at this time, the flexible structure 40 generates a rotating deformation to change the angle between the first cantilever 34 and the second cantilever 36, therefore the freedom of rotation is provided for the first module 22 when the first module 22 is being lifted. The first module being lifted causes a relative rotation center of the second module 24 to fall back at the end of the first module 22.

In the embodiment of the above-mentioned, the support component 44 utilizes the shaft 46 with two gears 48 to lift the first module 22 upwards, the support component of the present invention can also be formed by other components, for example utilizing a protruding object to lift the first module 22, its operational principles will be similar to the embodiment of the above-mentioned, therefore will not be further reiterated.

In comparison with the prior art, when the user slides open the electronic device of the present invention, the display panel of the upper module and the keypad of the lower module form an angle of greater than zero degrees. This provides the user with the convenience of an improved view and easier operation of the slide construction electronic device. This overcomes the defect of the view angle of the conventional slide construction mobile phone when viewing the display panel. Therefore, the present invention provides a more convenient electronic device for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a first module comprising a first flat surface;
a second module comprising a second flat surface;
a connection module coupled to the first module and the second module wherein the connection module is flexible, and the first flat surface and the second flat surface face each other; and
a support component installed on the second flat surface;
wherein when the first module is sliding relative to the second module, the first flat surface makes contact with the support component so that the connection module is deformed to change the angle in between the first module and the second module.

2. The electronic device of claim 1 wherein the connection module further comprises:
a first cantilever, fixed to an end of the first module; and
a second cantilever, coupled to the second module in a sliding manner.

3. The electronic device of claim 2 wherein the connection module further comprises: a flexible structure, wherein the first cantilever and the second cantilever are extended from the flexible structure, when the first module is sliding relative to the second module, the flexible structure is deformed to change the angle between the first cantilever and the second cantilever.

4. The electronic device of claim 2 wherein the second module further comprises a sliding track, formed on a top surface of the second module, the second cantilever slides on the sliding track and is coupled to the second module through the sliding track.

5. The electronic device of claim 3 wherein the flexible structure is a metallic plate.

6. The electronic device of claim 3 wherein the flexible structure is a rotating axle.

7. The electronic device of claim 1 wherein the support component comprises a shaft, and two gears sheathing the shaft in a rotating manner for lifting the first module upwards.

8. The electronic device of claim 7 wherein the first module further comprises a cavity for containing the gears of the support component.

9. The electronic device of claim 7 wherein the first module further comprises a plurality of trenches for engaging the two gears of the support component when the first module slides relative to the second module.

10. The electronic device of claim 7 wherein there is damping oil on a contact surface of the shaft and the gears.

11. The electronic device of claim 1 wherein the support component is a protruding object.

12. The electronic device of claim 1 wherein the second module further comprises a processing unit for controlling operations of the electronic device and a keypad for inputting control signals to the processing unit.

13. An electronic device with an angle of greater than zero degrees formed in between a first module and a second module, comprising:
a first module;
a sliding component, comprising:
a first cantilever fixed to the first module;
a second cantilever comprising a sliding portion; and
a flexible structure, the first cantilever and the second cantilever extend from the flexible structure, the flexible structure being deformed to change the angle between the first cantilever and the second cantilever;
a second module, having a sliding track formed on a top surface of the second module, the sliding portion slides on the sliding track and is coupled to the second module through the sliding track; and
a support component, protruding from the top surface of the second module, for lifting an end of the first module upwards when the sliding portion slides to a position that the first module makes contact with the support component so the flexible structure is deformed to change the angle between the first cantilever and the second cantilever.

14. The electronic device of claim 13 wherein the flexible structure is a metallic plate.

15. The electronic device of claim 13 wherein the flexible structure is a rotating axle.

16. The electronic device of claim 13 wherein the support component comprises a shaft, and two rollers sheathing the shaft in a rotating manner for lifting the first module upwards.

17. The electronic device of claim 16 wherein the first module further comprises a cavity for containing the rollers of the support component.

18. The electronic device of claim 16 wherein there is damping oil on a surface of the shaft and the rollers.

19. The electronic device of claim 13 wherein the support component is a protruding object.

20. The electronic device of claim 14 wherein the first module further comprises a display panel for displaying images.
